(19) United States
(12) Patent Application Publication
(10) Pub. No.: US 2007/0061225 A1
(43) Pub. Date: Mar. 15, 2007

(54) FACILITATING PROCUREMENT OF FOOD ITEMS

(75) Inventor: Peter Roy Havas, Double Bay NSW 2028 (AU)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Saxton Enterprises, Inc., DBA Specialty's Cafe & Bakery, San Francisco, CA (US)

(21) Appl. No.: 11/554,921

(22) Filed: Oct. 31, 2006

Related U.S. Application Data
(63) Continuation of application No. 10/206,682, filed on Jul. 26, 2002, now abandoned.
(60) Provisional application No. 60/307,841, filed on Jul. 27, 2001.

(51) Int. Cl. G06Q 30/00

(52) U.S. Cl. 705/27

(57) ABSTRACT

The present invention broadly relates to a procurement system and corresponding procurement method which enables a consumer to order a food item online by accessing the system and selecting the ingredients for the desired food item. After selecting the desired food item, an order signal is sent to a cell in the user's locality. The cell may then prepare and deliver the food item to the user.

### CROSS REFERENCE TO RELATED APPLICATION(S)

This application is a continuation of and claims the benefit of U.S. Nonprovisional application Ser. No. 10/206,682, filed Jul. 26, 2002, which claims the benefit of U.S. Provisional Application No. 60/307,841, filed Jul. 27, 2001.

### FIELD OF THE INVENTION

The present invention relates to electronic commerce. More particularly, the present invention relates to a solution for facilitating procurement of food items.

### BACKGROUND OF THE INVENTION

The procurement of food items such as sandwiches by visiting the premises of a seller has been known for centuries. In the case of sandwiches, it is common to select the ingredients required for the desired sandwich.

However, procuring food items by visiting the seller may be disadvantageous for the seller. Expensive premises are often required to sell the food items directly to the public. In addition, this arrangement also may be disadvantageous for consumers as it is necessary for the consumer to spend time visiting the premises of the seller in order to order the food item.

What is needed is a solution that allows a consumer to order a food item without visiting the seller's premises.

### BRIEF DESCRIPTION OF THE INVENTION

The present invention broadly relates to a procurement system and corresponding procurement method which enables a consumer to order a food item online by accessing the system and selecting the ingredients for the desired food item.

After selecting the desired food item, an order signal is sent to a cell in the user's locality. The cell may then prepare and deliver the food item to the user.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating a procurement system for facilitating procurement of a food item in accordance with a specific embodiment of the present invention.

FIG. 2 is a flow diagram illustrating a method for facilitating the procurement of food items in accordance with a specific embodiment of the present invention.

FIGS. 3-14 are screen captures illustrating example screens as displayed to a user in relation to operations undertaken in FIG. 2.

FIG. 15 is a flow diagram illustrating a method for facilitating the procurement of a food item in accordance with a specific embodiment of the present invention.

FIG. 16 is a flow diagram illustrating a method for facilitating the procurement of a food item at a central facility in accordance with a specific embodiment of the present invention.

FIG. 17 is a block diagram illustrating an apparatus for facilitating the procurement of a food item from a central facility in accordance with a specific embodiment of the present invention.

FIG. 18 is a block diagram illustrating an apparatus for facilitating the procurement of a food item at a central facility in accordance with a specific embodiment of the present invention.

### DETAILED DESCRIPTION OF A PREFERRED EMBODIMENT

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention broadly relates to a procurement system and corresponding procurement method which enables a consumer to order a food item online by accessing the system and selecting the ingredients for the desired food item. After selecting the desired food item, an order signal is sent to a cell in the user's locality. The cell may then prepare and deliver the food item to the user.

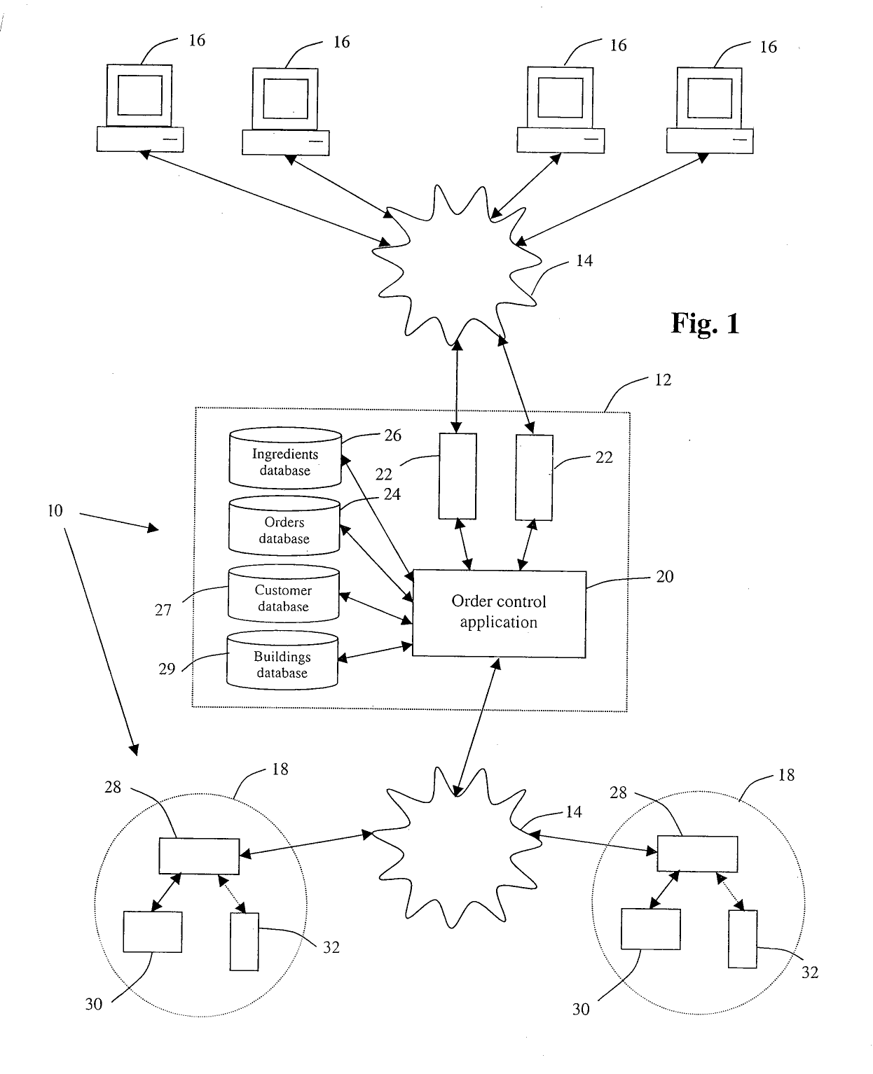

FIG. 1 is a block diagram illustrating a procurement system for facilitating procurement of a food item in accordance with a specific embodiment of the present invention. The procurement system 10 includes an order processing unit 12 which receives orders for food items from users, manages the received orders and distributes the received orders to food item preparation and delivery facilities 18 for preparation of corresponding food items and delivery of the food items to the requesting users.

The order processing unit 12 may be accessed online using any suitable communications mechanism, in this example the Internet 14. The users may connect to the order processing unit 12 using any suitable interface device, in this example personal computing devices 16. However, it will be understood that other communications enabled devices are also envisaged as suitable for performing the function of an interface device, such as mobile telephones, personal digital assistants (PDA), and so on.

The order processing unit 12 is arranged to provide users with a range of food ingredients available for selection as ingredients of a food item, to create orders for food items based on the selected ingredients, and to communicate with a plurality of food item preparation and delivery facilities 18 so as to thereby coordinate preparation of the ordered food items. Each facility 18 may be associated with a particular geographical area referred to in this specification as a cell.

The order processing unit 12 may include an order control application 20 for controlling and coordinating operation of the order processing unit 12, web servers 22 for communicating with the personal computing devices 16 through the Internet 14, an orders database 24 for storing orders received from the personal computing devices 16, an ingredients database 26 for storing food ingredients which are selectable by a user, a customer database 27 for storing customer related information, and a buildings database 29 for storing building location information for each cell.

The order control application 20 may be arranged to cooperate with the web servers 22 so as to provide web pages which can be presented to a user on a website accessible by the computing devices 16. The website may contain information describing operation of the system and provides a user-friendly interface with which the user can interact to order and pay for a desired food item.

The order control application 20 may also be arranged to time-stamp each of the orders with a date and delivery time label indicative of the date and delivery time at which the user wishes to receive the food item. Once an order has been time-stamped, the order may be forwarded by the order control application 20 to the orders database 24 for storage. At predetermined intervals, each facility 18 contacts the order processing unit 12 with a request for orders relevant to the facility 18 and, when the current date and time of an order is within a predetermined period before the chosen date and delivery time, for example 30 minutes, the order is retrieved from the orders database 24 by the order control application of the facility 18 closest to the ordering user.

The order control application 20 may also be arranged to communicate with the ingredients database 26, the customer database 27 and the buildings database 29 so as to coordinate transfer of records from and to the ingredients database 26, the customer database 27, and the building database 29.

The order control application 20 is also arranged to receive and process payments from users by credit card and/or by debiting appropriate payments from user accounts. The user accounts may be arranged to allow payments to be debited from the user accounts only when adequate funds have been transferred to the user accounts, or to allow payments to be debited from the user accounts irrespective of the amount of funds available. In the latter example, the system 10 may be arranged to invoice the respective users as and when necessary. Payments received may be from users via credit card or by any other suitable payment method.

Each of the web servers 22 may be arranged to interact with computing devices 16 in a particular location. For example, a first web server 22 may be arranged to interact with computing devices 16 in Australia and a second web server 22 may be used to interact with computing devices 16 in the United States. As an alternative, each web server 22 may be arranged to interact with computing devices in a particular time zone.

The ingredients database 26 may be arranged to store a plurality of ingredients which may be included in a food item, and to store predefined groups of ingredients which correspond to predefined food items. For example, a predefined group of ingredients including white bread, cheddar cheese, and pickle may be stored in the ingredients database 26 as a food item “cheese and pickle sandwich”.

The customer database 27 may be arranged to store personal, demographic and/or accounts details of users of the system 10. For example, the customer database 27 may store login names and associated passwords for each user, a link to the buildings database which identifies the default delivery address for each user, details of the remaining credit available to each user, and so on.

The buildings database 29 may be arranged to store information relating to the address of each building in each cell associated with the system 10. The information may be categorized into locality, street and building name and may be used to facilitate selection by a user of the appropriate address to which a food item is to be delivered. It will be understood that by providing such a mechanism for selecting the delivery address, the risk of error and/or inconsistency in entering the delivery address is minimized.

The facilities 18 may be arranged to communicate with the order processing unit 12 using any suitable communications mechanism. In this example, the facilities 18 communicate with the order processing unit 12 through the Internet 14.

Each facility 18 is arranged to service a particular cell and includes a facility control application 28 for coordinating and processing received orders, a printer 30 for printing orders and associated labels, and a scanner 32 for tracking order processing and delivery of food items.

The facility control application 28 may be arranged to receive orders from the order processing unit 12, and in this example includes a print control application arranged to instruct the printer 30 to print the orders, and a scanner control application arranged to interact with the scanner 32 so as to receive order processing and delivery information from the scanner 32.

Each order printed by the printer 30 may be in the form of two labels, although it will be appreciated that any number of labels may be used. A first label may include a list of the ingredients required to make the food item, the delivery date and time for the food item, and a machine readable identifier which may be used to identify the food item. It will be understood that the ingredients list on the first label may be used by personnel at the order receiving cell as preparation instructions for the food item. The first label may also include other additional information such as the name of the ordering user, an identification name chosen by the user for the food item such as for example “my sandwich”, and/or the price of the food item.

As well as serving to identify the ingredients required for the food item, the first label may be applied to a package containing the prepared food item for identification. The machine readable identifier may be a bar code which is readable by the scanner 32 and, in operation, the bar code on the first label is scanned after the food item has been prepared so as to generate a ready signal indicative that the food item is ready for delivery. The ready signal may be transferred to the order processing unit 12 for storage and the ready signal is made available for review by users on the website so that the users can track preparation of the food item.

A second label may include the address of the user, the food item name selected by the user for the food item, the delivery time for the food item, and a machine readable identifier, in this example a bar code which is the same as the bar code printed on the first label and which is readable by the scanner 32 so as to identify the food item.

In operation, the bar code on the second label may be scanned after the food item has been delivered so as to generate a delivered signal indicating that the food item has been delivered. The delivered signal is transferred to the order processing unit 12 for storage and the delivered signal is made available for review by users on the website so that the users can track delivery of the food item. The delivered signal may also be used to trigger other processes, such as creation of an invoice where appropriate, or forwarding of a confirmation e-mail to the relevant user.

The scanner 32 is a hand-held device which is arranged to read machine readable identifiers, in this example bar codes. The scanner 32 may be arranged to communicate with the cell control application 28 by any suitable communications mechanism, for example by wireless communication using a suitable platform such as Bluetooth, or by a readily connectable and disconnectable wired connection.

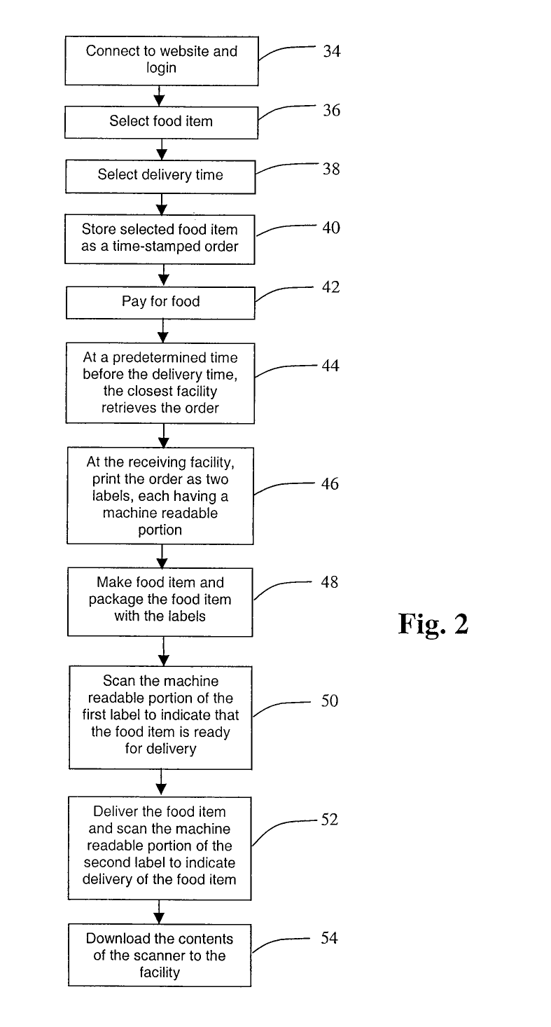

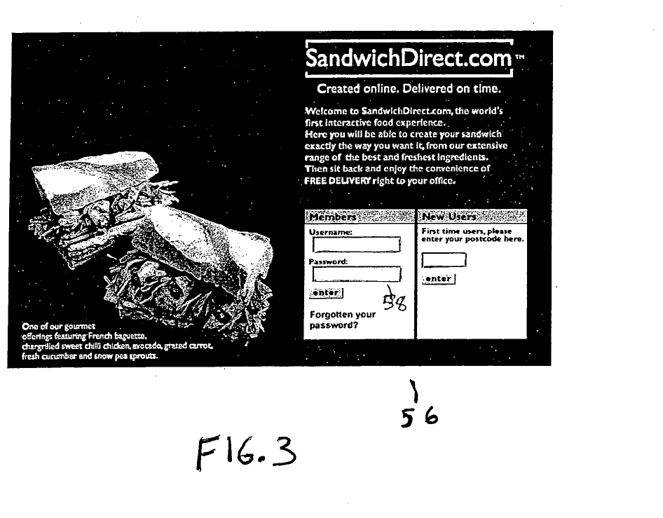

FIG. 2 is a flow diagram illustrating a method for facilitating the procurement of food items in accordance with a specific embodiment of the present invention. FIGS. 3-14 are screen captures illustrating example screens as displayed to a user in relation to operations undertaken in FIG. 2.

To order a food item, a user connects to the order processing unit 12 using a computing device 16 and the user is presented with a website login page 56 shown in FIG. 3. The user then may enter a login name and a password using login boxes 58, as indicated at 34 of FIG. 2.

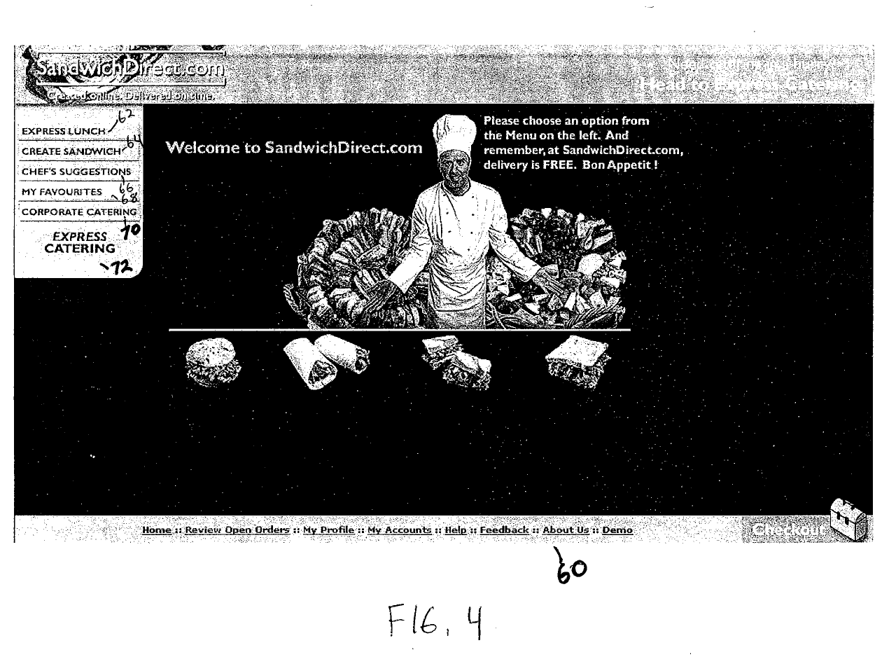

The user may then presented with a home screen 60 as shown in FIG. 4. Using the home screen 60, a user is able to select an order option using option buttons 62, 64, 66, 68, 70, 72.

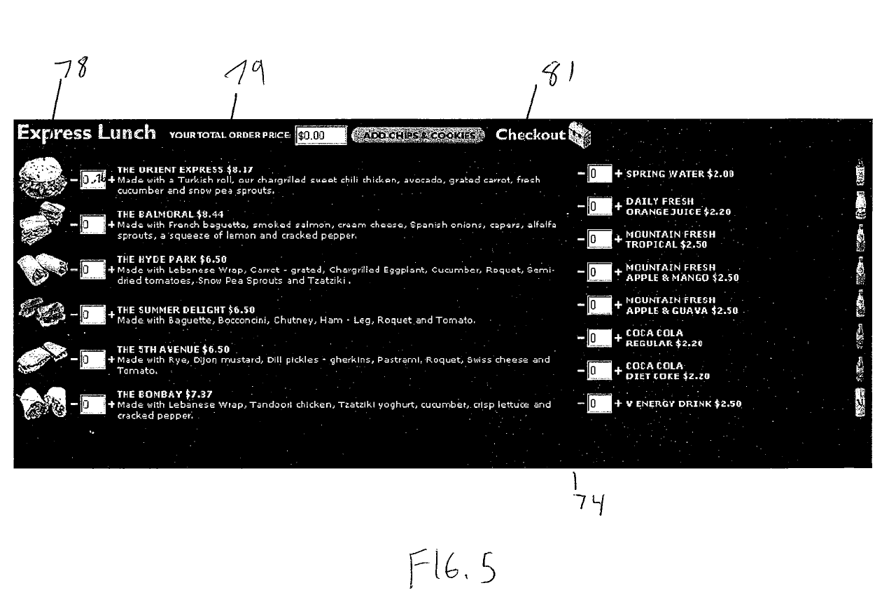

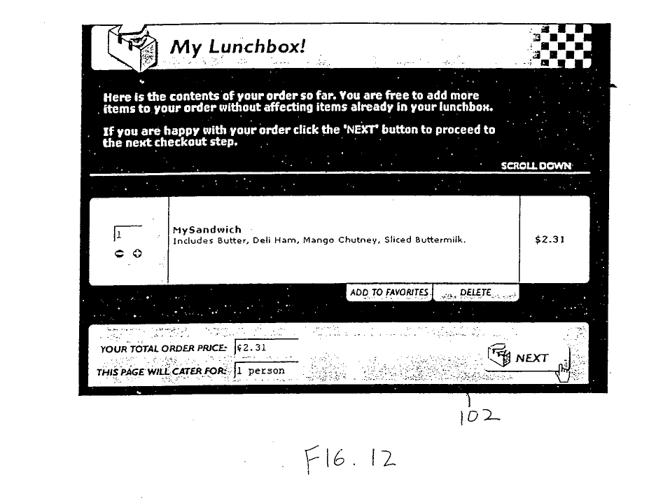

When an express lunch option button 62 is selected, the user may be presented with an express lunch screen 74 as shown in FIG. 5. The express lunch screen 74 enables a user to order predefined food items, and for this purpose each food item includes a quantity box 76 for indicating the required number of food items, a food item graphical representation 78 and a food item description 79 which describes the ingredients and price of the food item. After a selection has been made by a user, the user may activate a checkout button 81, which transfers the user to an order summary screen 102 shown in FIG. 12.

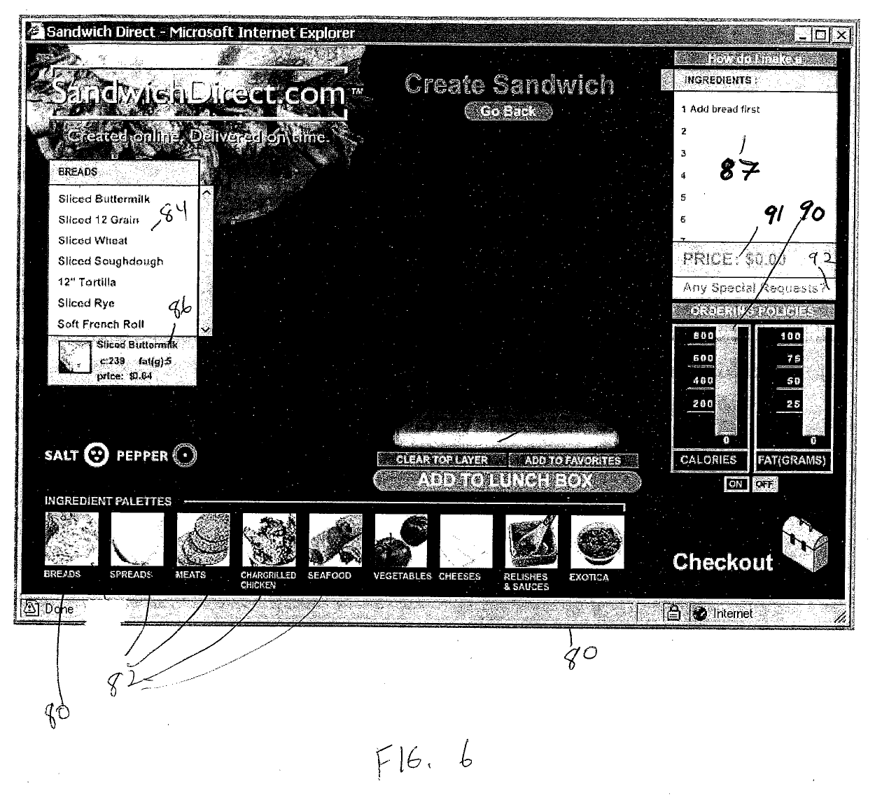

When a create sandwich button 64 is selected, the user may be presented with a create sandwich screen 80 shown in FIG. 6. The create sandwich screen 80 enables a user to create and order customized food items. The create sandwich screen 80 may include a plurality of ingredients palettes 82, each of which corresponds to a particular class of food ingredients such as “breads”, “meats”, “cheeses”, and so on. When a user activates one of the ingredients palettes 82, for example by clicking on an ingredients palette 82 using a mouse, an available ingredients box 84 including ingredients belonging to the selected class of food ingredients may be displayed. For example, when a bread ingredients palette 82 is activated, a range of user selectable breads is displayed in the ingredients box 84. The user is also able to view an ingredients information box 86 a graphical representation of a food ingredient and the calorie content and fat content of the food ingredient by locating a mouse cursor over the food ingredient in the ingredients box 84.

The create sandwich screen 80 may also include a graphical representation of a chopping board 88 on which representations of food ingredients appear when selected, a selected ingredients box 87 in which the selected ingredients are listed, food item information charts 90 which include cumulative calorie content information and cumulative fat content information for the food item, a price box 91 which indicates the cumulative total price payable for the food item, and a special requests button 92 which may be activated to enable entry of special instruction for preparation of the food item such as “extra mayonnaise”. It will be understood that other information relating to the food ingredients and food item may also be displayed, such as for example the dietary fibre content of each food ingredient.

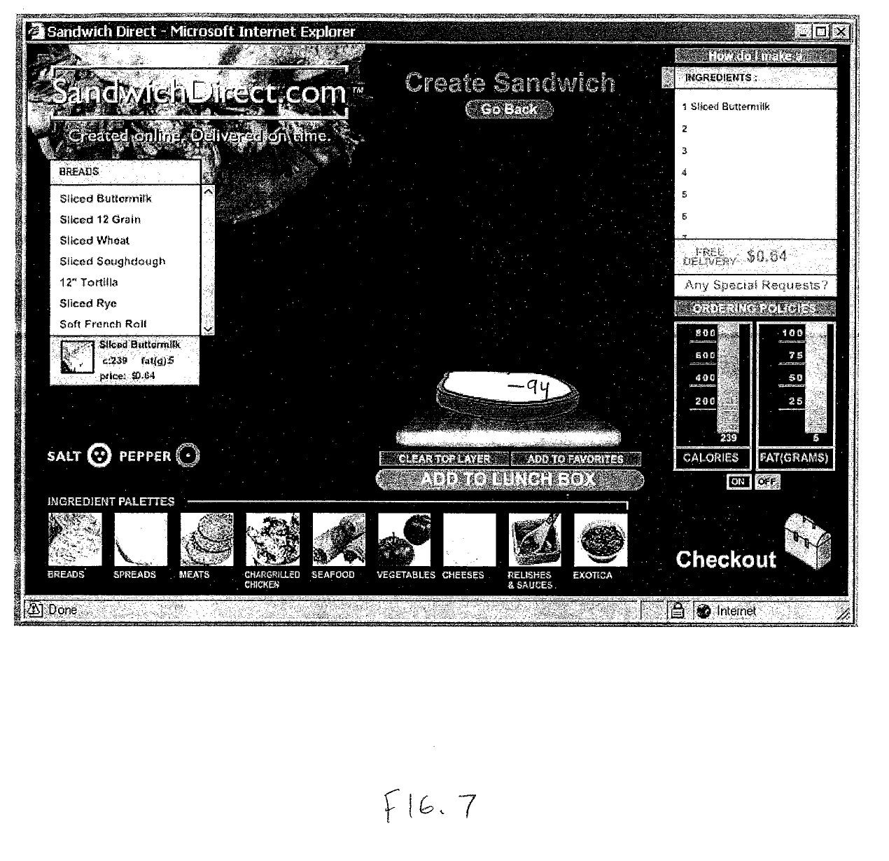

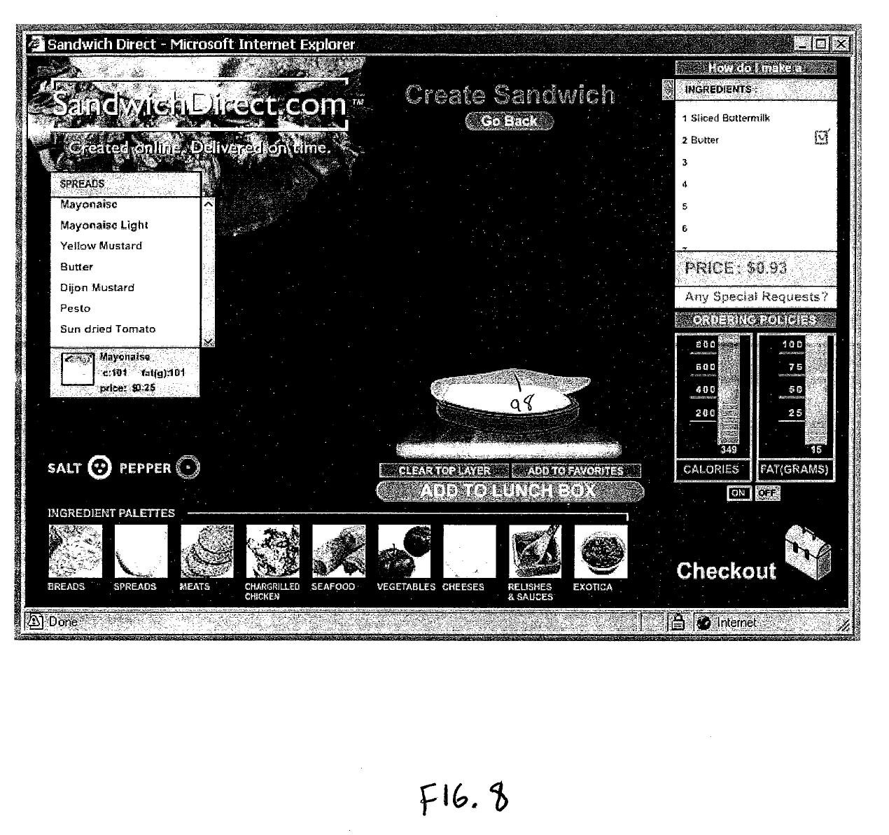

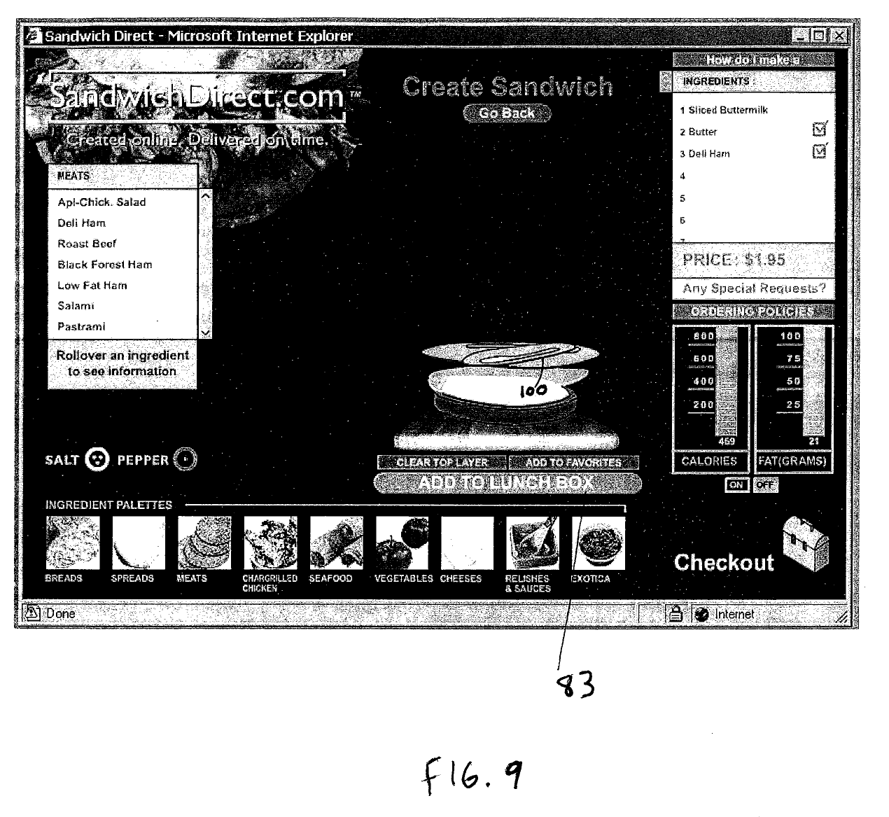

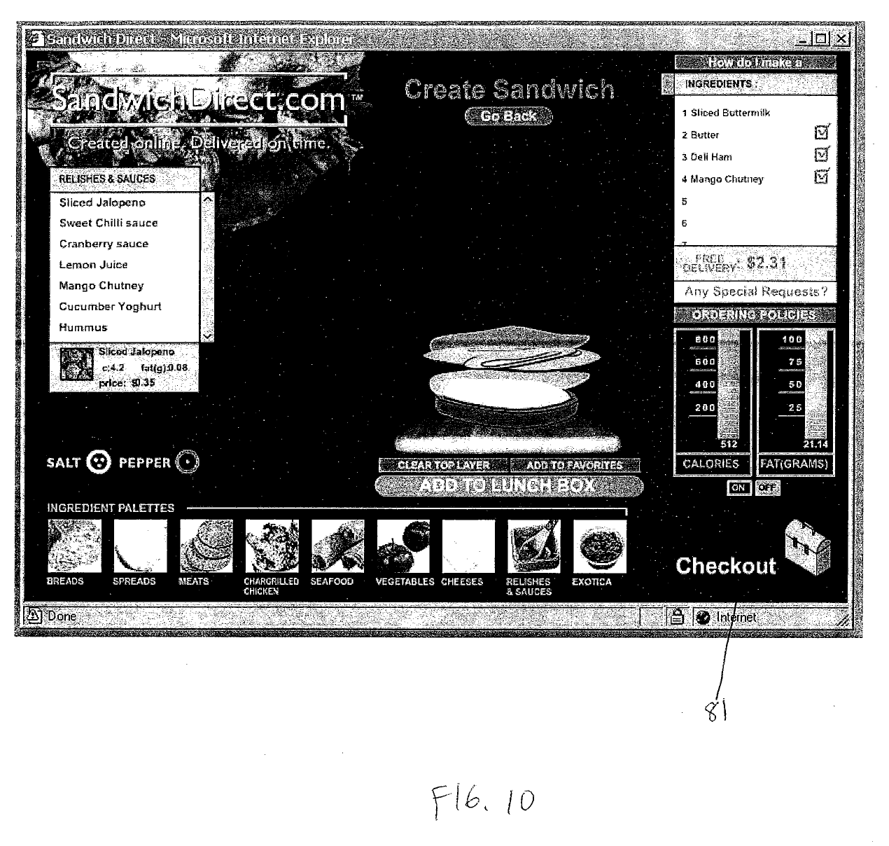

FIGS. 7 to 10 show the changes to the create sandwich screen 80 which occur as food ingredients are selected. FIG. 7 shows a graphical representation of a food item including sliced white bread 94, FIG. 8 shows a representation of the food item further including margarine 96, FIG. 9 shows a representation of the food item further including ham 98, and FIG. 10 shows a representation of the food item further including English mustard 100.

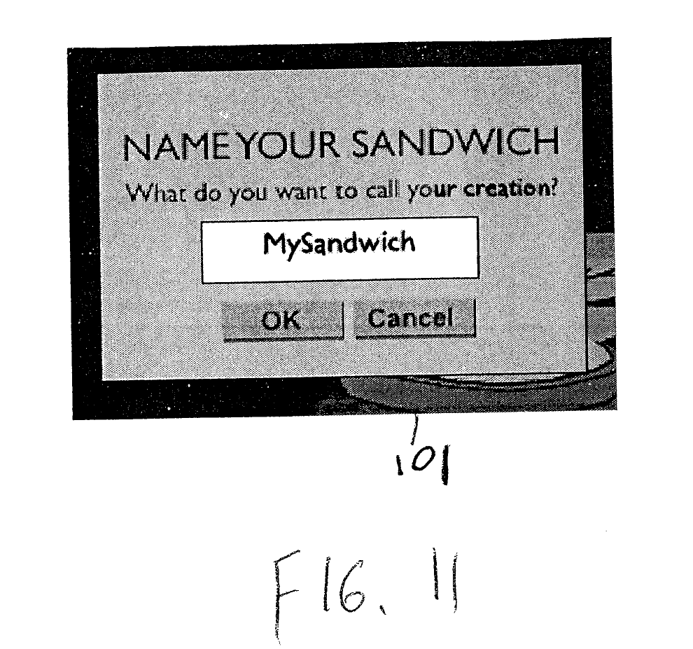

When all desired food ingredients have been selected by the user, the user may activate an add food item button 83 which causes the food item to be associated with the user. The user may then be transferred to a name food item screen 101 as shown in FIG. 11. Using this screen, the user is able to enter a chosen name for the food item. If the user does not enter a chosen name, a default name “my sandwich” may be used. After a selection has been made by a user, the user may activate checkout button 81, which transfers the user to the order summary screen 102 shown in FIG. 12.

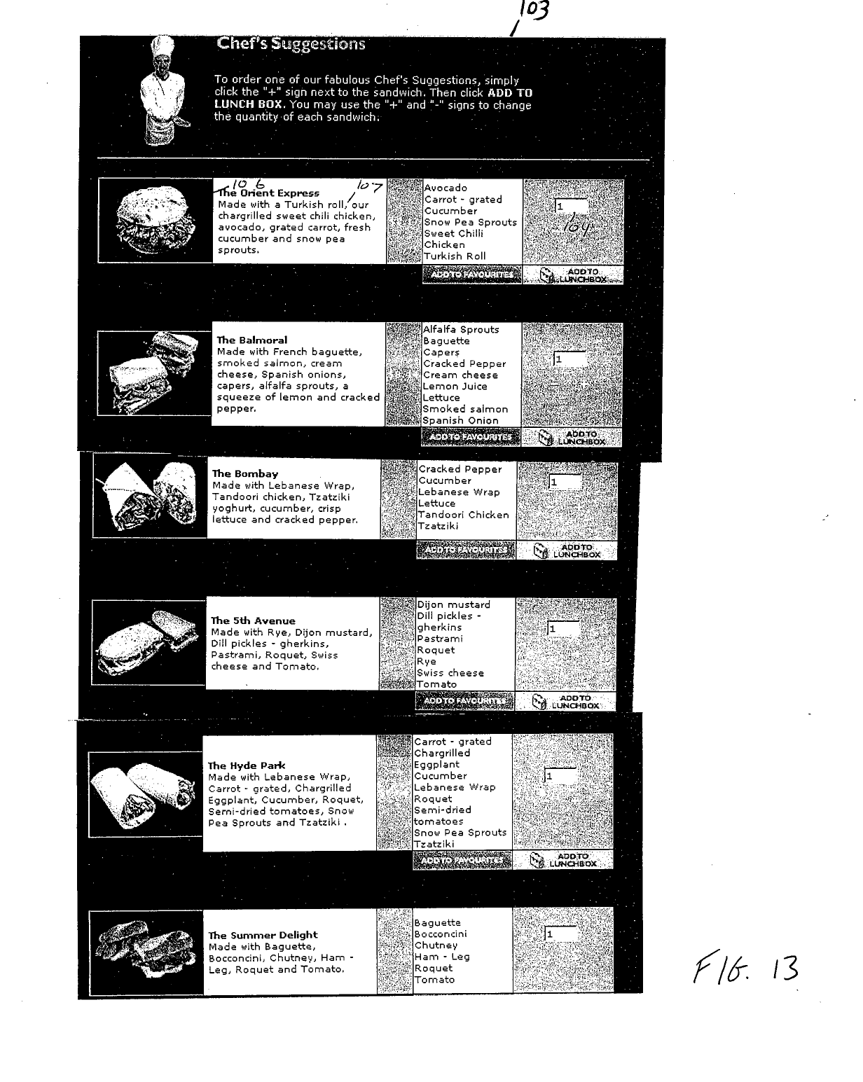

When a chef's suggestions button 66 is selected, the user is presented with a chef's suggestions screen 103 as shown in FIG. 13. The chef's suggestions screen 103 enables a user to order predefined food items which are recommended to the user by operators of the system 10. For this purpose, each food item may include a quantity box 104 for indicating the required number of food items, a food item graphical representation 106 and a food item description 107 which describes the ingredients and price of the food item. After a selection has been made by a user, the user activates checkout button 81 which transfers the user to the order summary screen 102 shown in FIG. 12.

When a my favourites button 68 is selected, the user may be presented with a favourites screen (not shown) which operates essentially in the same way as the chefs suggestions screen 103. However, the favourites screen includes only food items which have been flagged by a user for storage and future use. The food items displayed on the favourites screen may be derived either from food items which have been created by the user or from predetermined food items. The favourites screen may be arranged to facilitate editing of the food items displayed on the favourites screen. For example, selection of an appropriate icon on the favourites screen corresponding to a food item may direct the user to the create sandwich screen 80 with the food ingredients for the food item being displayed on the chopping board 88.

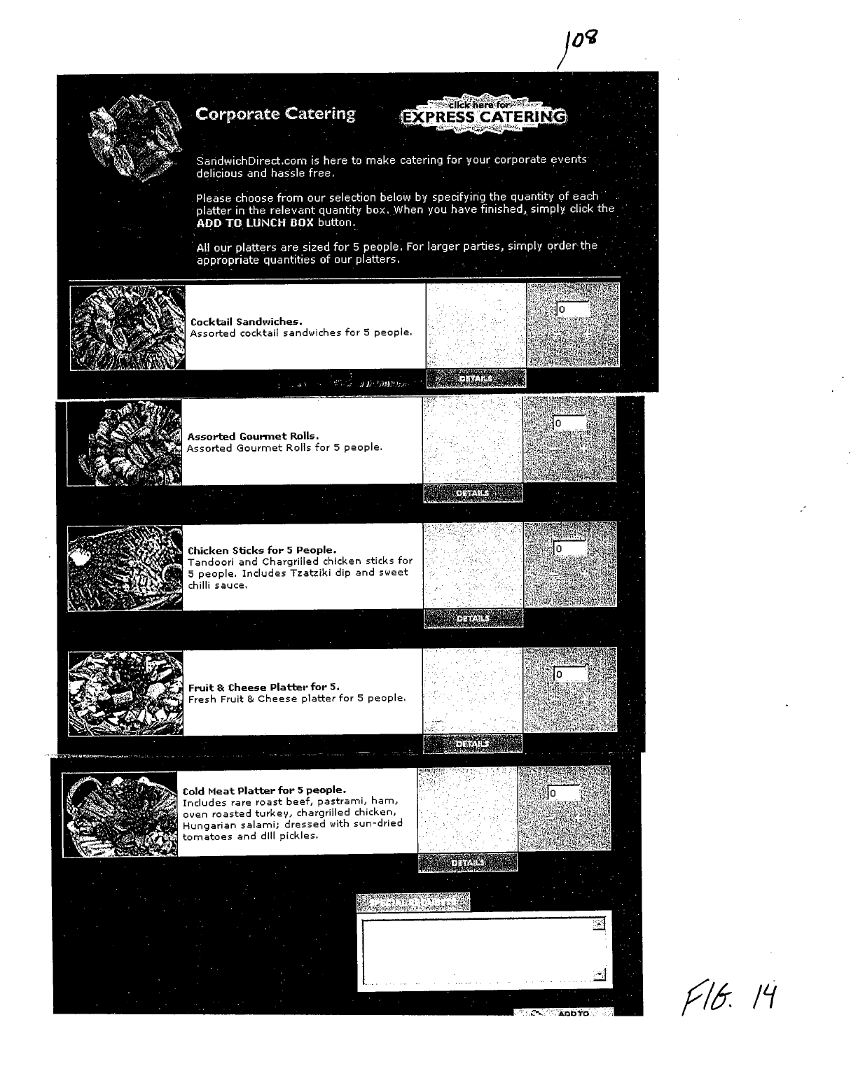

When a corporate catering button 70 or a breakfast platters button 72 is selected, the user may be presented with a corporate catering screen 108 shown in FIG. 14 or a breakfast platters screen (not shown) respectively. It will be understood that the corporate catering screen 108 and the breakfast platters screen operate in essentially the same way as the chef's suggestions screen 66.

The above described actions carried out in relation to the express lunch screen 74, the create sandwich screen 80, the chefs suggestions screen 103, the my favourites screen, the corporate catering screen 108 and the breakfast platters screen constitute a place order action wherein a user selects the desired food items. This action is indicated at 36 of FIG. 2.

In addition to ordering the above described food items, additional screens may be provided for facilitating purchase of ancillary food items such as beverages, chips, cookies and fruit.

After placing an order for a food item, the user may be presented with the order summary screen 102, which indicates the quantity, name, price and ingredients of the selected food items. To confirm the order described on the order summary screen 102, a user activates a next button 110. The user is then requested to indicate the desired delivery date and time for the ordered food item, with the earliest possible delivery time being used as a default. The earliest possible delivery time may be derived using a real-time clock. However, it will be understood that the earliest possible delivery time may be modifiable by operators of the system, for example so as to take into account busy or quiet periods of activity. This action is indicated at 38 of FIG. 2.

The created food item order and associated date and delivery time are then stored in the orders database 24, as indicated at 40 of FIG. 2. The user may then be presented with a payments screen (not shown), which enables the user to pay for the ordered food items. In this example, the payment screen allows a user to pay by credit card or to allocate funds from the users account. Funds may be applied to the users account for future use in any suitable way, for example, by using a credit card. This action is indicated at 42 in FIG. 2.

At predetermined intervals, each facility 18 may contact the order processing unit 12 with a request for orders relevant to the facility and, when the current date and time approaches the date and delivery time associated with an order stored in the orders database 24, the facility 18 closest to the user may retrieve the order from the orders database 24. The most appropriate facility 18 for the user may be determined by using the users address information stored in the buildings database 29. This action is indicated at 44 of FIG. 2.

When the receiving facility 18 receives the order from the order processing unit 12, the order may be processed by the facility control application 28 and the above described two labels are printed by the printer 30. The first label is used by personnel associated with the system 10 to prepare the food item and is applied to a package in which the food item is placed when prepared. The second label is applied to a bag in which the package is located during transport to the user. As discussed above, each of the first and second labels may include a bar code which identifies the food item and which is readable by the scanner 32. This action is indicated at 46 of FIG. 2.

After printing the two labels, the food item may be prepared by personnel at the facility 18, as indicated at 48 of FIG. 2 and, when preparation of the food item is complete, the bar code on the first label may be read using the scanner 32. This causes a ready signal to be generated which indicates that the food item is ready for delivery to the user. This action is indicated at 50 of FIG. 2.

The food item may then be delivered to the user at the address indicated on the second label and, when delivery of the food item is complete, the bar code on the second label is read by the scanner 32 to indicate delivery of the food item to the user. This action is indicated at step 52 of FIG. 2.

After completion of delivery, the delivery person may return to the facility 18 and transfer the delivery signal stored in the scanner 32 to the cell control application 28 for transferring to the order control application.

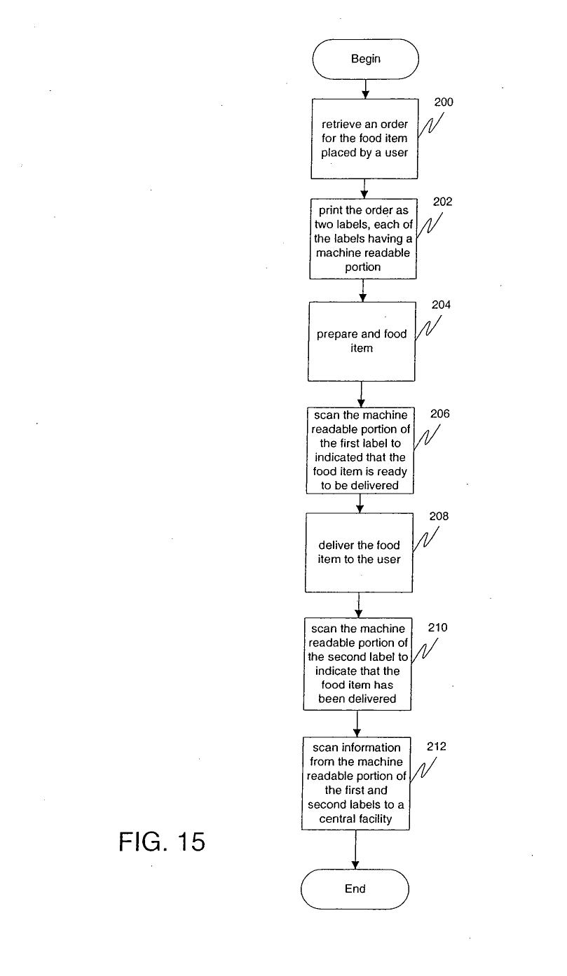

FIG. 15 is a flow diagram illustrating a method for facilitating the procurement of a food item in accordance with a specific embodiment of the present invention. At 200, an order for the food item placed by a user is retrieved. This may comprise retrieving an order for the food item placed by a user from a central facility where the order was placed. At 202, the order is printed as two labels, each of the labels having a machine readable portion. At 204, the food item is prepared. At 206, the food item is packaged with the two labels. At 208, the machine readable portion of the first label is scanned to indicate that the food item is ready to be delivered. At 210, the food item is delivered to the user. At 212, the machine readable portion of the second label is scanned to indicate that the food item has been delivered. At 214, information scanned from the machine readable portion of the first and second labels is uploaded to a central facility. All these processes may be performed by a facility closest to the user.

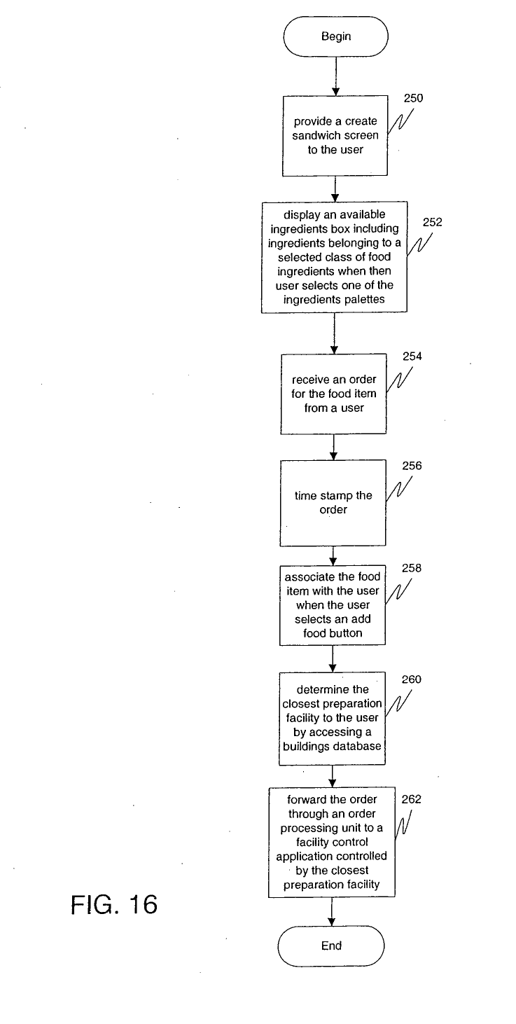

FIG. 16 is a flow diagram illustrating a method for facilitating the procurement of a food item at a central facility in accordance with a specific embodiment of the present invention. At 250, a create sandwich screen may be provided to the user. The create sandwich screen may comprise a plurality of ingredients palettes. It may also comprise a graphic representation of a chopping board on which representations of food ingredients appear when selected, food information charts including cumulative calories content information and cumulative fat content information for the food item, a price box which indicates a cumulative total price payable for the food item, and a special requests button. At 252, an available ingredients box may be displayed including ingredients belonging to a selected class of food ingredients when the user selects one of the ingredients palettes. At 254, an order for the food item is received from a user. At 256, the order may be time stamped. At 258, the food item is associated with the user when the user selects an add food button. At 260, a closest preparation facility to the user may be determined by accessing a buildings database. At 262, the order may be forwarded through an order processing unit to a facility control application controlled by the closest preparation facility. This may occur at a predetermined interval.

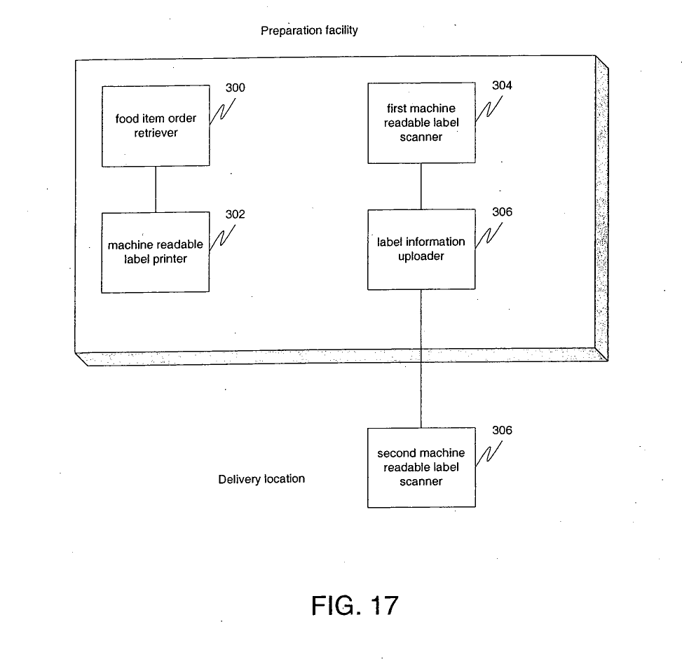

FIG. 17 is a block diagram illustrating an apparatus for facilitating the procurement of a food item from a central facility in accordance with a specific embodiment of the present invention. A food item order retriever 300 communicatively coupled to the central facility may retrieve an order for the food item placed by a user. A machine readable label printer 302 coupled to the food item order retriever 300 may print the order as two labels, each of the labels having a machine readable portion. The food item may then be prepared and packaged with the two labels. A first machine readable label scanner 304 communicatively coupled to the central facility may scan the machine readable portion of the first label to indicate that the food item is ready to be delivered. A label information uploader 306 coupled to the first machine readable label scanner 304 and to the central facility may upload information scanned from the machine readable portion of the first label to the central facility. The food item may then be delivered to the user. A second machine readable label scanner 308 communicatively coupled to the central facility may scan the machine readable portion of the second label to indicate that the food item has been delivered. The label information uploader 306 may upload information scanned from the machine readable portion of the second label to the central facility. All these processes may be performed by a facility closest to the user.

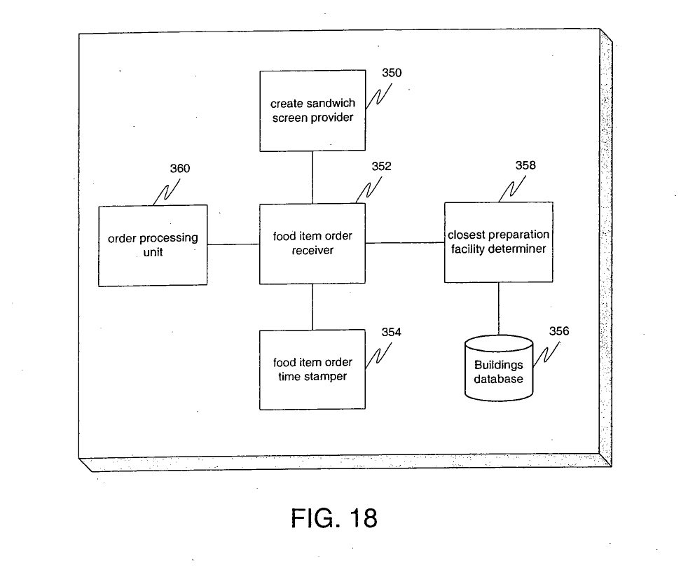

FIG. 18 is a block diagram illustrating an apparatus for facilitating the procurement of a food item at a central facility in accordance with a specific embodiment of the present invention. A create sandwich screen provider 350 may provide a create sandwich screen to the user. The create sandwich screen may comprise a plurality of ingredients palettes. It may also comprise a graphic representation of a chopping board on which representations of food ingredients appear when selected, food information charts including cumulative calories content information and cumulative fat content information for the food item, a price box which indicates a cumulative total price payable for the food item, and a special requests button. An available ingredients box may be displayed including ingredients belonging to a selected class of food ingredients when the user selects one of the ingredients palettes. A food item order receiver 352 coupled to the create sandwich screen provider 350 may receive an order for the food item from a user. A food item order time stamper 354 coupled to the food item order receiver 352 may time stamp the order. The food item is associated with the user when the user selects an add food button. A buildings database 356 may contain the locations of preparation facilities and a closest preparation facility determiner 358 coupled to the food item order receiver 352 and the buildings database 356 may determine a closest preparation facility to the user. An order processing unit 360 may be coupled to the food item order receiver 352 may forward the order to a facility control application controlled by the closest preparation facility. This may occur at a predetermined interval.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for facilitating the procurement of a food item, comprising:
retrieving an order for the food item placed by a user;
printing said order as two labels, each of said labels having a machine readable portion;
preparing the food item;
packaging the food item with said two labels;
scanning said machine readable portion of said first label to indicate that the food item is ready for delivery;
delivering the food item to the user; and
scanning said machine readable portion of said second label to indicate that the food item has been delivered.

2. The method of claim 1, further comprising receiving an order for the food item from a user at a central facility.

3. The method of claim 2, wherein said retrieving an order further comprises retrieving an order for the food item placed by a user from said central facility.

4. The method of claim 1, further comprising uploading information scanned from said machine readable portion of said first and second labels to a central facility.

5. The method of claim 1, further comprising determining a facility closest to the user.

6. The method of claim 5, wherein said retrieving, printing, preparing, packaging, scanning, delivering the food item to the user, and scanning are performed by said facility closest to the user.

7. A method for facilitating the procurement of a food item at a central facility, comprising:
receiving an order for the food item from a user;
determining a closest preparation facility to the user by accessing a buildings database; and
forwarding said order through an order processing unit to a facility control application controlled by said closest preparation facility.

8. The method of claim 7, further comprising:
providing a create sandwich screen to the user.

9. The method of claim 8, wherein said create sandwich screen comprises a plurality of ingredients palettes.

10. The method of claim 9, further comprising displaying an available ingredients box including ingredients belonging to a selected class of food ingredients when the user selects one of said ingredients palettes.

11. The method of claim 10, wherein each ingredient in said available ingredients box includes a graphical representation of said ingredient and a calorie and fat content of said food ingredient.

12. The method of claim 8, wherein said create sandwich screen comprises a graphical representation of a chopping board on which representations of food ingredients appear when selected.

13. The method of claim 8, wherein said create sandwich screen comprises food information charts including cumulative calorie content information and cumulative fat content information for the food item.

14. The method of claim 8, wherein said create sandwich screen comprises a price box which indicates a cumulative total price payable for the food item.

15. The method of claim 8, wherein said create sandwich screen comprises a special requests button.

16. The method of claim 7, wherein the food item is associated with the user when the user selects an add food item button.

17. The method of claim 7, wherein said forwarding occurs at a predetermined interval.

18. The method of claim 7, further including time-stamping said order.

19. An apparatus for facilitating the procurement of a food item from a central facility, comprising:
a food item order retriever communicatively coupled to the central facility;
a machine readable label printer coupled to said food item order retriever;
a first machine readable label scanner communicatively coupled to the central facility; and
a second machine readable label scanner communicatively coupled to the central facility.

20. The apparatus of claim 19, further comprising a label information uploader coupled to said first machine readable label scanner and to said central facility.

21. The apparatus of claim 19, further comprising a label information uploader coupled to said second first machine readable label scanner and to said central facility.

22. An apparatus for facilitating the procurement of a food item at a central facility, comprising:
a food item order receiver;
a buildings database;
a closest preparation facility determiner coupled to said food item order receiver and to said buildings database; and
an order processing unit coupled to said food item order receiver.

23. The apparatus of claim 22, further comprising a create sandwich screen provider coupled to said food item order receiver.

24. The apparatus of claim 22, further comprising a food item order time stamper coupled to said food item order receiver.

25. An apparatus for facilitating the procurement of a food item, comprising:
means for retrieving an order for the food item placed by a user;
means for printing said order as two labels, each of said labels having a machine readable portion;
means for preparing the food item;
means for packaging the food item with said two labels;
means for scanning said machine readable portion of said first label to indicate that the food item is ready for delivery;
means for delivering the food item to the user; and
means for scanning said machine readable portion of said second label to indicate that the food item has been delivered.

26. The apparatus of claim 25, further comprising means for receiving an order for the food item from a user at a central facility.

27. The apparatus of claim 26, wherein said means for retrieving an order further comprises means for retrieving an order for the food item placed by a user from said central facility.

28. The apparatus of claim 26, further comprising means for uploading information scanned from said machine readable portion of said first and second labels to a central facility.

29. The apparatus of claim 25, further comprising means for determining a facility closest to the user.

30. The apparatus of claim 29, wherein said means for retrieving, means for printing, means for preparing, means for packaging, means for scanning, means for delivering the food item to the user, and means for scanning are performed by said facility closest to the user.

31. An apparatus for facilitating the procurement of a food item at a central facility, comprising:
means for receiving an order for the food item from a user;
means for determining a closest preparation facility to the user by accessing a buildings database; and
means for forwarding said order through an order processing unit to a facility control application controlled by said closest preparation facility.

32. The apparatus of claim 31, further comprising:
means for providing a create sandwich screen to the user.

33. The apparatus of claim 32, wherein said create sandwich screen comprises a plurality of ingredients palettes.

34. The apparatus of claim 33, further comprising means for displaying an available ingredients box including ingredients belonging to a selected class of food ingredients when the user selects one of said ingredients palettes.

35. The apparatus of claim 34, wherein each ingredient in said available ingredients box includes a graphical representation of said ingredient and a calorie and fat content of said food ingredient.

36. The apparatus of claim 32, wherein said create sandwich screen comprises a graphical representation of a chopping board on which representations of food ingredients appear when selected.

37. The apparatus of claim 32, wherein said create sandwich screen comprises food information charts including cumulative calorie content information and cumulative fat content information for the food item.

38. The apparatus of claim 32, wherein said create sandwich screen comprises a price box which indicates a cumulative total price payable for the food item.

39. The apparatus of claim 32, wherein said create sandwich screen comprises a special requests button.

40. The apparatus of claim 31, wherein the food item is associated with the user when the user selects an add food item button.

41. The apparatus of claim 31, wherein said means for forwarding occurs at a predetermined interval.

42. The apparatus of claim 31, further including means for time-stamping said order.
